(19) United States
(12) Patent Application Publication
(10) Pub. No.: US 2014/0112667 A1
(43) Pub. Date: Apr. 24, 2014

(54) SYSTEMS, COMPONENTS, AND METHODS FOR PROVIDING LOCATION SERVICES FOR MOBILE/WIRELESS CLIENT DEVICES IN DISTRIBUTED ANTENNA SYSTEMS USING ADDITIONAL SIGNAL PROPAGATION DELAY

(71) Applicant: CORNING CABLE SYSTEMS LLC, Hickory, NC (US)

(72) Inventors: Ulrich W. Neukirch, Painted Post, NY (US); Anthony Ng'Oma, Horseheads, NY (US)

(73) Assignee: CORNING CABLE SYSTEMS LLC, Hickory, NC (US)

(21) Appl. No.: 14/138,580

(22) Filed: Dec. 23, 2013

Related U.S. Application Data
(63) Continuation of application No. PCT/US11/49122, filed on Aug. 25, 2011.

(51) Int. Cl. H04B 10/2575; H04W 16/18

(52) U.S. Cl. CPC H04B 10/25752; H04W 16/18
USPC 398/115

(57) ABSTRACT

Systems, components, and methods for providing location services for mobile/wireless client devices in distributed antenna systems using additional signal propagation delay are disclosed. The location of a client device communicating with an antenna in the distributed antenna system can be correlated to location within at least the communication range of an antenna. To determine with which particular antenna within the distributed antenna system a client device is communicating, the antennas within the distributed antenna system are uniquely identified. In this regard, additional propagation delays are introduced in the communication paths between some or all of the antennas and the head-end equipment in distributed antenna systems to distinguish communications between different antennas. The additional propagation delay can be correlated with a unique antenna, which in turn can be correlated to distance within the distributed antenna system.

### PRIORITY APPLICATIONS

This application is a continuation application of International Application No. PCT/US11/49122 filed Aug. 25, 2011, which is hereby incorporated herein by reference.

### RELATED APPLICATIONS

The present application is related to PCT Patent Application No. PCT/US10/44884 filed on Aug. 9, 2010 entitled “Apparatuses, Systems, and Methods for Determining Location of a Mobile Device(s) in a Distributed Antenna System(s),” which is incorporated herein by reference in its entirety.

The present application is also related to PCT Patent Application No. PCT/US11/29895 filed on Mar. 25, 2011 entitled “Localization Services In Optical Fiber-based Distributed Communications Components and Systems, and Related Methods,” which is incorporated herein by reference in its entirety, and which claims priority to U.S. Provisional Patent Application Ser. No. 61/319,659 filed on Mar. 31, 2010, entitled “Localization Services In Optical Fiber-based Distributed Communications Components And Systems, and Related Methods.”

### BACKGROUND

1. Field of the Disclosure

The technology of the disclosure relates to systems and related components and methods for determining location of mobile/wireless client devices communicating in distributed antenna systems.

2. Technical Background

Wireless communication is rapidly growing, with ever-increasing demands for high-speed mobile data communication. As an example, so-called “wireless fidelity” or “WiFi” systems and wireless local area networks (WLANs) are being deployed in many different types of areas (e.g., coffee shops, airports, libraries, etc.). Distributed communications or antenna systems communicate with wireless devices called “clients,” which must reside within the wireless range or “cell coverage area” in order to communicate with an access point device.

One approach to deploying a distributed antenna system involves the use of radio frequency (RF) antenna coverage areas, also referred to as “antenna coverage areas.” Antenna coverage areas can have a radius in the range from a few meters up to twenty meters as an example. Combining a number of access point devices creates an array of antenna coverage areas. Because the antenna coverage areas each cover small areas, there are typically only a few users (clients) per antenna coverage area. This allows for minimizing the amount of RF bandwidth shared among the wireless system users. It may be desirable to provide antenna coverage areas in a building or other facility to provide distributed antenna system access to clients within the building or facility. However, it may be desirable to employ optical fiber to distribute communications signals. Benefits of optical fiber include increased bandwidth.

One type of distributed antenna system for creating antenna coverage areas, called “Radio-over-Fiber” or “RoF,” utilizes RF signals sent over optical fibers. Such systems can include head-end equipment optically coupled to a plurality of remote antenna units that each provide antenna coverage areas. The remote antenna units can each include RF transceivers coupled to an antenna to transmit RF signals wirelessly, wherein the remote antenna units are coupled to the head-end equipment via optical fiber links. The RF transceivers in the remote antenna units are transparent to the RF signals. The remote antenna units convert incoming optical RF signals from an optical fiber downlink to electrical RF signals via optical-to-electrical (O/E) converters, which are then passed to the RF transceiver. The RF transceiver converts the electrical RF signals to electromagnetic signals via antennas coupled to the RF transceiver provided in the remote antenna units. The antennas also receive electromagnetic signals (i.e., electromagnetic radiation) from clients in the antenna coverage area and convert them to electrical RF signals (i.e., electrical RF signals in wire). The remote antenna units then convert the electrical RF signals to optical RF signals via electrical-to-optical (E/O) converters. The optical RF signals are then sent over an optical fiber uplink to the head-end equipment.

It may be desired to provide such distributed antenna systems in shadow areas, high rise structures, indoors (e.g., inside a building or other facility), or other environments where communications signals may be attenuated or obstructed. In this regard, the remote antenna units can be distributed throughout locations inside a building to extend wireless communication coverage throughout the building. It may be desired or required to provide localization services for a client in these environments, i.e., determine the location of the client device within the distributed antenna system. One application where determining the location of client devices is desired or required is emergency 911 (E911) services. Another example where determining location of client devices may be desired is to provide targeted or contextual information, such as advertisements, to the client devices based on their location. However, it may be difficult or not possible to determine the location of clients in the environments of the distributed antenna systems. For example, it may not be possible to use global positioning services (GPSs) to determine the location of the client devices due to blockage or attenuation of the GPS signals in the environment of the distributed antenna systems. Further, triangulation or other techniques from the outside network may not be able to determine the location of the client in these environments.

### SUMMARY OF THE DETAILED DESCRIPTION

Embodiments disclosed in the detailed description include systems, components, and methods for providing location services for mobile/wireless client devices in distributed antenna systems using additional signal propagation delay. The embodiments disclosed herein support determining the location of mobile and/or wireless client devices by determining the antenna unit with which the distributed antenna system the client device is communicating. The location of a client device communicating with an antenna in the distributed antenna system can be correlated to a location within at least the communication range of an antenna. The locations of the antennas in the distributed antenna system can be configured during installation, setup, or maintenance of the distributed antenna system for correlation of such locations to client devices. The location of the antennas may be configured to be a geographic location that does not depend on further information for knowledge of location or a location relative to the head-end equipment or other location in the distributed antenna system.

Thus, embodiments disclosed herein provide different additional signal propagation delays (“additional propagation delay”) for some or all of the antennas and the head-end equipment in distributed antenna systems. The additional propagation delay is pre-configured to correspond to a particular antenna in the distributed antenna system and its location. During communications sessions with client devices, a determination is made with which antenna in the distributed antenna system, a client device is communicating. Location determination can be made by correlating the propagation delay of communication signals from the client device communicating through an antenna in the distributed antenna system with propagation delays pre-configured for the antennas. The identification of the antenna can then in turn be correlated to a previously configured location within the distributed antenna system to determine the location of the client device communication with the antenna. After the additional propagation delay is correlated to location for a given communication session with a client device, other systems or components may then provide or facilitate providing signal propagation delay equalization for the communication session with the client device.

Although not required, the additional propagation delay of communication paths configured for antennas in the distributed antenna systems can also be provided in relation to their distance from head-end equipment. For example, antennas located closer to the head-end equipment may be configured with less additional propagation delay than antennas located farther away from the head-end equipment.

In this regard in one embodiment, a distributed antenna system is provided. The distributed antenna system comprises a plurality of remote antenna units (RAU) each configured to communicate received downlink radio-frequency (RF) communications signals wirelessly to client devices and configured to receive uplink RF communications signals wirelessly from the client devices. The distributed antenna system also comprises head-end equipment (HEE). The HEE is configured to receive the downlink RF communications signals from a base station and distribute the received downlink communication RF signals over a plurality of downlink communications paths comprising a plurality of downlink communications medium each coupled to one of the plurality of remote antenna units (RAUs). The HEE is further configured to receive uplink RF communications signals over a plurality of uplink communications paths comprising a plurality of uplink communications medium each coupled to one of the plurality of RAUs. At least one of additional uplink delay component is provided in one or more of the uplink communications paths to increase to signal propagation delay of the uplink RF communications signals such that each of the plurality of uplink communications paths has a unique actual signal propagation delay to uniquely identify the plurality of RAUs from the actual signal propagation delay of the uplink RF communications signals.

In another embodiment, a method of determining the location of a client device in a distributed antenna system is provided. The method includes determining the actual signal propagation delay for an uplink RF communications signal received from a remote antenna unit (RAU) among a plurality of RAUs each configured to communicate received downlink radio-frequency (RF) communications signals wirelessly to client devices and configured to receive uplink RF communications signals wirelessly from client devices. The method also includes correlating the actual signal propagation delay to the identity of the RAU among the plurality of RAUs to identify the RAU involved with the uplink RF communications signal. The method also includes correlating the location of the client device communicating the uplink RF communications signal to the identified RAU with a pre-configured location of the identified RAU.

In another embodiment, a system is provided comprised of a first distributed antenna system. The first distributed antenna system comprises a plurality of first remote antenna units (RAU) each configured to communicate first received downlink radio-frequency (RF) communications signals wirelessly to client devices and configured to receive first uplink RF communications signals wirelessly from the client devices. The first distributed antenna system also comprises head end equipment (HEE) configured to receive the first downlink RF communications signals from a base station and distribute the first received downlink communication RF signals over a first plurality of downlink communications paths comprising a first plurality of downlink communications medium each coupled to one of the first plurality of remote antenna units (RAUs), and receive first uplink RF communications signals over a plurality of first uplink communications paths comprising a first plurality of uplink communications medium each coupled to one of the first plurality of RAUs. A first additional delay component is provided between the base station and the first distributed antenna system to increase the signal propagation delay of the first uplink RF communications signals such that each of the first plurality of uplink communications paths has a unique actual signal propagation delay to uniquely identify the first distributed antenna system to the base station. The system also comprises a second distributed antenna system. The second distributed antenna system is comprised of a plurality of second remote antenna units (RAU) each configured to communicate second received downlink radio-frequency (RF) communications signals wirelessly to client devices and configured to receive second uplink RF communications signals wirelessly from the client devices. The second distributed antenna system is also comprised of head-end equipment (HEE) configured to receive the second downlink RF communications signals from the base station and distribute the second received downlink communication RF signals over a second plurality of downlink communications paths comprising a second plurality of downlink communications medium each coupled to one of the second plurality of remote antenna units (RAUs), and receive second uplink RF communications signals over a plurality of second uplink communications paths comprising a second plurality of uplink communications medium each coupled to one of the second plurality of RAUs. A second additional delay component is provided between the base station and the second distributed antenna system to increase the signal propagation delay of the second uplink RF communications signals such that each of the second plurality of uplink communications paths has a unique actual signal propagation delay to uniquely identify the second distributed antenna system to the base station.

As a non-limiting example, the distributed antenna system may be an optical fiber-based distributed antenna system, but such is not required. The embodiments disclosed herein are also applicable to other distributed antenna systems, including those that include other forms of communications media for distribution of communications signals, including electrical conductors and wireless transmission. The embodiments disclosed herein may also be applicable to distributed antenna system and may also include more than one communications media for distribution of communications signals (e.g., RF communications services, digital data services).

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification.

### BRIEF DESCRIPTION OF THE FIGURES

FIG. 1 is a schematic diagram of an exemplary distributed antenna system;

FIG. 2 is a more detailed schematic diagram of exemplary head-end equipment (HEE) and a remote antenna unit (RAU) that can be deployed in the distributed antenna system of FIG. 1;

FIG. 3A is a partially schematic cut-away diagram of an exemplary building infrastructure in which the distributed antenna system in FIG. 1 can be employed;

FIG. 3B is an alternative diagram of the distributed antenna system in FIGS. 1-3A;

FIG. 4 is schematic diagram of a modified distributed antenna system of the distributed antenna system in FIGS. 1-3B employing additional signal propagation delay components to introduce additional signal propagation delay in the communications paths between the HEE and the RAUs to uniquely identify RAUs;

FIG. 5 is a flowchart illustrating an exemplary process of providing additional propagation delays for RAUs in a distributed antenna system and configuring a database with the resulting measured propagation delays of the RAUs to uniquely identify the RAUs for correlation to a location in the distributed antenna system;

FIG. 6 is an exemplary look-up table containing entries for RAUs to correlate actual propagation delay of communications signals to identification and location of the RAUs;

FIG. 7 is a flowchart illustrating an exemplary process of establishing a communication session with a client device in the distributed antenna system and mapping actual propagation delay of communications involving the client device to the identification and location of a RAU receiving the communications from the client device to determine the location of the client device;

FIG. 8 is schematic diagram illustrating a plurality of the distributed antenna systems in FIG. 4 employing additional signal propagation delay components between the HEEs of the distributed antenna systems and the BTS to distinguish and identify RAUs among different distributed antenna systems;

FIG. 9 is a schematic diagram of an exemplary optical fiber-based distributed antenna system with alternative equipment to provide RF communication services over optical fiber and digital data services as electrical signals to RAUs or other remote communications devices in an optical fiber-based distributed antenna system; and

FIG. 10 is a schematic diagram of a generalized representation of an exemplary computer system that can be included in any of the modules provided in the exemplary distributed antenna systems and/or their components described herein, wherein the exemplary computer system is adapted to execute instructions from an exemplary computer-readable media.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include systems, components, and methods for providing location services for mobile/wireless client devices in distributed antenna systems using additional signal propagation delay. The embodiments disclosed herein support determining the location of mobile and/or wireless client devices by determining the antenna unit with which the distributed antenna system the client device is communicating. The location of a client device communicating with an antenna in the distributed antenna system can be correlated to a location within at least the communication range of an antenna. The locations of the antennas in the distributed antenna system can be configured during installation, setup, or maintenance of the distributed antenna system for correlation of such locations to client devices. The location of the antennas may be configured to be a geographic location that does not depend on further information for knowledge of location or a location relative to the head-end equipment or other location in the distributed antenna system.

Thus, embodiments disclosed herein provide different additional signal propagation delays (“additional propagation delay”) for some or all of the antennas and the head-end equipment in distributed antenna systems. The additional propagation delay is pre-configured to correspond to a particular antenna in the distributed antenna system and its location. During communications sessions with client devices, a determination is made with which antenna in the distributed antenna system, a client device is communicating. Location determination can be made by correlating the propagation delay of communication signals from the client device communicating through an antenna in the distributed antenna system with propagation delays pre-configured for the antennas. The identification of the antenna can then in turn be correlated to a previously configured location within the distributed antenna system to determine the location of the client device communicating with the antenna. After the additional propagation delay is correlated to location for a given communication session with a client device, other systems or components may then provide or facilitate providing signal propagation delay equalization for the communication session with the client device.

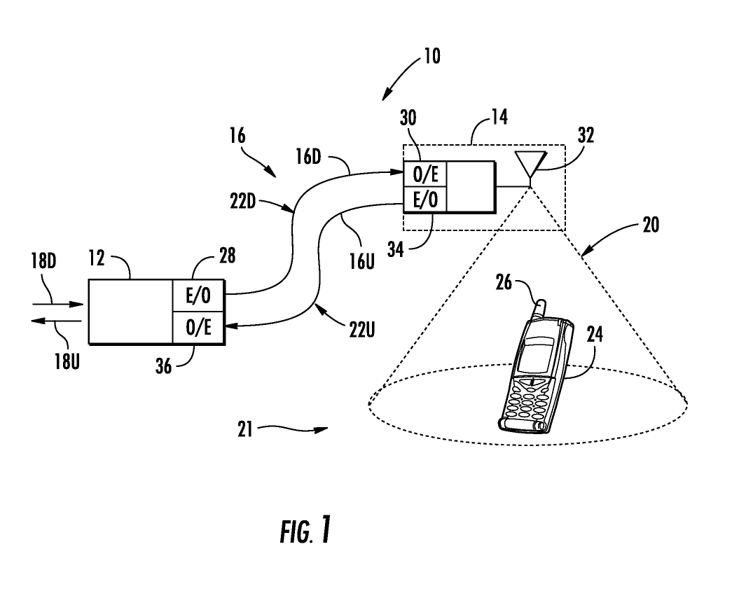

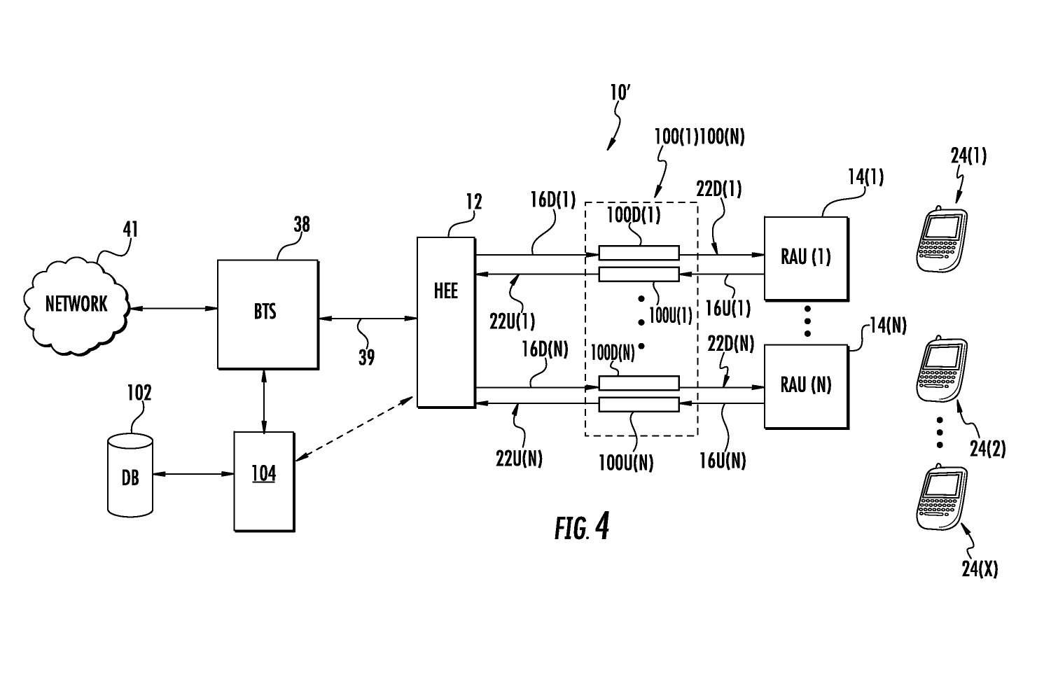

Before discussing examples of distributed antenna systems that support providing location services for mobile/wireless client devices using additional signal propagation delay, an exemplary distributed antenna systems capable of distributing RF communications signals to distributed or remote antenna units is first described with regard to FIGS. 1-3B. Examples of distributed antenna systems that support providing location services for mobile/wireless devices using additional signal propagation delay are shown at FIG. 4. The distributed antenna systems in FIGS. 1-3B discussed below include distribution of radio frequency (RF) communications signals; however, the distributed antenna systems are not limited to distribution of RF communications signals. Also note that while the distributed antenna systems in FIGS. 1-3B discussed below include distribution of communications signals over optical fiber, these distributed antenna systems are not limited to distribution over optical fiber. Distribution mediums could also include, but are not limited to, coaxial cable, twisted-pair conductors, wireless transmission and reception, and any combination thereof. Also, any combination can be employed that also involves optical fiber for portions of the distributed antenna system.

In this regard, FIG. 1 is a schematic diagram of an embodiment of a distributed antenna system 10. In this embodiment, the distributed antenna system 10 is an optical fiber-based distributed antenna system. The distributed antenna system 10 is configured to create one or more antenna coverage areas for establishing communications with wireless client devices located in the RF range of the antenna coverage areas. The distributed antenna system 10 provides RF communication services (e.g., cellular services). In this embodiment, the distributed antenna system 10 includes head-end equipment (HEE) 12 such as a head-end unit (HEU), one or more remote antenna units (RAUs) 14, and an optical fiber 16 that optically couples the HEE 12 to the RAU 14. The RAU 14 is a type of remote communications unit. In general, a remote communications unit can support either wireless communications, wired communications, or both. The RAU 14 can support wireless communications and may also support wired communications. The HEE 12 is configured to receive communications over downlink electrical RF signals 18D from a source or sources, such as a network or carrier as examples, and provide such communications to the RAU 14. The HEE 12 is also configured to return communications received from the RAU 14, via uplink electrical RF signals 18U, back to the source or sources. In this regard in this embodiment, the optical fiber 16 includes at least one downlink optical fiber 16D to carry signals communicated from the HEE 12 to the RAU 14 and at least one uplink optical fiber 16U to carry signals communicated from the RAU 14 back to the HEE 12.

One downlink optical fiber 16D and one uplink optical fiber 16U could be provided to support multiple channels each using wave-division multiplexing (WDM), as discussed in U.S. patent application Ser. No. 12/892,424 entitled “Providing Digital Data Services in Optical Fiber-based Distributed Radio Frequency (RF) Communications Systems, And Related Components and Methods,” incorporated herein by reference in its entirety. Other options for WDM and frequency-division multiplexing (FDM) are disclosed in U.S. patent application Ser. No. 12/892,424, any of which can be employed in any of the embodiments disclosed herein. Further, U.S. patent application Ser. No. 12/892,424 also discloses distributed digital data communications signals in a distributed antenna system which may also be distributed in the distributed antenna system 10 either in conjunction with RF communications signals or not.

The distributed antenna system 10 has an antenna coverage area 20 that can be disposed about the RAU 14. The antenna coverage area 20 of the RAU 14 forms an RF coverage area 21. The HEE 12 is adapted to perform or to facilitate any one of a number of Radio-over-Fiber (RoF) applications, such as RF identification (RFID), wireless local-area network (WLAN) communication, or cellular phone service. Shown within the antenna coverage area 20 is a client device 24 in the form of a mobile device as an example, which may be a cellular telephone as an example. The client device 24 can be any device that is capable of receiving RF communications signals. The client device 24 includes an antenna 26 (e.g., a wireless card) adapted to receive and/or send electromagnetic RF signals.

With continuing reference to FIG. 1, to communicate the electrical RF signals over the downlink optical fiber 16D to the RAU 14, to in turn be communicated to the client device 24 in the antenna coverage area 20 formed by the RAU 14, the HEE 12 includes a radio interface in the form of an electrical-to-optical (E/O) converter 28. The E/O converter 28 converts the downlink electrical RF signals 18D to downlink optical RF signals 22D to be communicated over the downlink optical fiber 16D. The RAU 14 includes an optical-to-electrical (O/E) converter 30 to convert received downlink optical RF signals 22D back to electrical RF signals to be communicated wirelessly through an antenna 32 of the RAU 14 to client devices 24 located in the antenna coverage area 20.

Similarly, the antenna 32 is also configured to receive wireless RF communications from client devices 24 in the antenna coverage area 20. In this regard, the antenna 32 receives wireless RF communications from client devices 24 and communicates electrical RF signals representing the wireless RF communications to an E/O converter 34 in the RAU 14. The E/O converter 34 converts the electrical RF signals into uplink optical RF signals 22U to be communicated over the uplink optical fiber 16U. An O/E converter 36 provided in the HEE 12 converts the uplink optical RF signals 22U into uplink electrical RF signals, which can then be communicated as uplink electrical RF signals 18U back to a network or other source. The HEE 12 in this embodiment is not able to distinguish the location of the client devices 24 in this embodiment. The client device 24 could be in the range of any antenna coverage area 20 formed by an RAU 14.

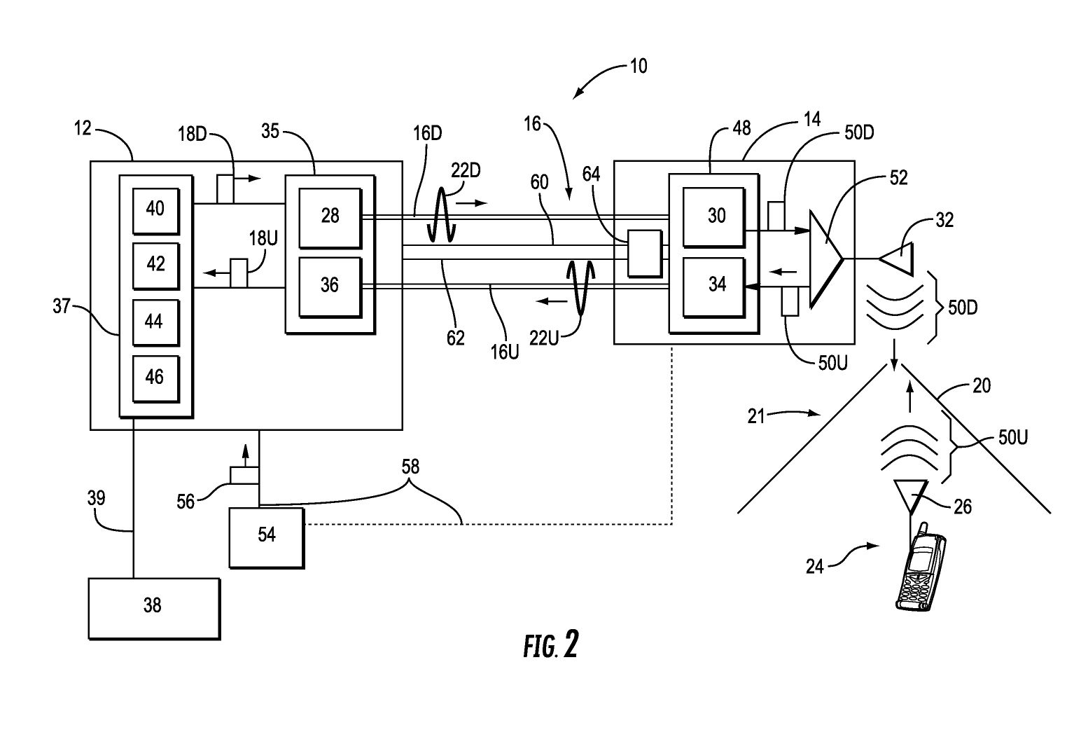

FIG. 2 is a more detailed schematic diagram of the exemplary distributed antenna system 10 of FIG. 1 that provides electrical RF service signals for a particular RF service or application. In an exemplary embodiment, the HEE 12 includes a service unit 37 that provides electrical RF service signals by passing (or conditioning and then passing) such signals from one or more outside systems 38 via a network link 39. As a non-limiting example, the outside system 38 may be a base station or base transceiver station (BTS). The BTS 38 may be provided by a second party such as a cellular service provider, and can be co-located or located remotely from the HEE 12. A BTS is any station or signal source that provides an input signal to the HEE 12 and can receive a return signal from the HEE 12.

In a typical cellular system, for example, a plurality of BTSs are deployed at a plurality of remote locations to provide wireless telephone coverage. Each BTS serves a corresponding cell and when a mobile client device enters the cell, the BTS communicates with the mobile client device. Each BTS can include at least one radio transceiver for enabling communication with one or more subscriber units operating within the associated cell. As another example, wireless repeaters or bi-directional amplifiers could also be used to serve a corresponding cell in lieu of a BTS. Alternatively, radio input could be provided by a repeater, picocell, or femtocell as other examples.

In a particular example embodiment, cellular signal distribution in the frequency range from 400 MegaHertz (MHz) to 2.7 GigaHertz (GHz) are supported by the distributed antenna system 10. Any other electrical RF signal frequencies are possible. In another exemplary embodiment, the service unit 37 provides electrical RF service signals by generating the signals directly. In another exemplary embodiment, the service unit 37 coordinates the delivery of the electrical RF service signals between client devices 24 within the antenna coverage area 20.

With continuing reference to FIG. 2, the service unit 37 is electrically coupled to the E/O converter 28 that receives the downlink electrical RF signals 18D from the service unit 37 and converts them to corresponding downlink optical RF signals 22D. In an exemplary embodiment, the E/O converter 28 includes a laser suitable for delivering sufficient dynamic range for the RoF applications described herein, and optionally includes a laser driver/amplifier electrically coupled to the laser. Examples of suitable lasers for the E/O converter 28 include, but are not limited to, laser diodes, distributed feedback (DFB) lasers, Fabry-Perot (FP) lasers, and vertical cavity surface emitting lasers (VCSELs).

With continuing reference to FIG. 2, the HEE 12 also includes the O/E converter 36, which is electrically coupled to the service unit 37. The O/E converter 36 receives the uplink optical RF signals 22U and converts them to corresponding uplink electrical RF signals 18U. In an example embodiment, the O/E converter 36 is a photodetector, or a photodetector electrically coupled to a linear amplifier. The E/O converter 28 and the O/E converter 36 constitute a “converter pair” 35, as illustrated in FIG. 2.

In accordance with an exemplary embodiment, the service unit 37 in the HEE 12 can include an RF signal conditioner unit 40 for conditioning the downlink electrical RF signals 18D and the uplink electrical RF signals 18U, respectively. The service unit 37 can include a digital signal processing unit (“digital signal processor”) 42 for providing to the RF signal conditioner unit 40 an electrical signal that is modulated onto an RF carrier to generate a desired downlink electrical RF signal 18D. The digital signal processor 42 is also configured to process a demodulation signal provided by the demodulation of the uplink electrical RF signal 18U by the RF signal conditioner unit 40. The HEE 12 can also include an optional central processing unit (CPU) 44 for processing data and otherwise performing logic and computing operations, and a memory unit 46 for storing data, such as data to be transmitted over a WLAN or other network for example.

With continuing reference to FIG. 2, the RAU 14 also includes a converter pair 48 comprising the O/E converter 30 and the E/O converter 34. The O/E converter 30 converts the received downlink optical RF signals 22D from the HEE 12 back into downlink electrical RF signals 50D. The E/O converter 34 converts uplink electrical RF signals 50U received from the client device 24 into the uplink optical RF signals 22U to be communicated to the HEE 12. The O/E converter 30 and the E/O converter 34 are electrically coupled to the antenna 32 via an RF signal-directing element 52, such as a circulator for example. The RF signal-directing element 52 serves to direct the downlink electrical RF signals 50D and the uplink electrical RF signals 50U, as discussed below. In accordance with an exemplary embodiment, the antenna 32 can include any type of antenna, including but not limited to one or more patch antennas, such as disclosed in U.S. patent application Ser. No. 11/504,999, filed Aug. 16, 2006 entitled “Radio-over-Fiber Transponder With A Dual-Band Patch Antenna System,” and U.S. patent application Ser. No. 11/451,553, filed Jun. 12, 2006 entitled “Centralized Optical Fiber-Based Wireless

Picocellular Systems and Methods,” both of which are incorporated herein by reference in their entireties.

With continuing reference to FIG. 2, the distributed antenna system 10 also includes a power supply 54 that provides an electrical power signal 56. The power supply 54 is electrically coupled to the HEE 12 for powering the power-consuming elements therein. In an exemplary embodiment, an electrical power line 58 runs through the HEE 12 and over to the RAU 14 to power the O/E converter 30 and the E/O converter 34 in the converter pair 48, the optional RF signal-directing element 52 (unless the RF signal-directing element 52 is a passive device such as a circulator for example), and any other power-consuming elements provided. In an exemplary embodiment, the electrical power line 58 includes two wires 60 and 62 that carry a single voltage and are electrically coupled to a DC power converter 64 at the RAU 14. The DC power converter 64 is electrically coupled to the O/E converter 30 and the E/O converter 34 in the converter pair 48, and changes the voltage or levels of the electrical power signal 56 to the power level(s) required by the power-consuming components in the RAU 14. In an exemplary embodiment, the DC power converter 64 is either a DC/DC power converter or an AC/DC power converter, depending on the type of electrical power signal 56 carried by the electrical power line 58. In another example embodiment, the electrical power line 58 (dashed line) runs directly from the power supply 54 to the RAU 14 rather than from or through the HEE 12. In another example embodiment, the electrical power line 58 includes more than two wires and may carry multiple voltages.

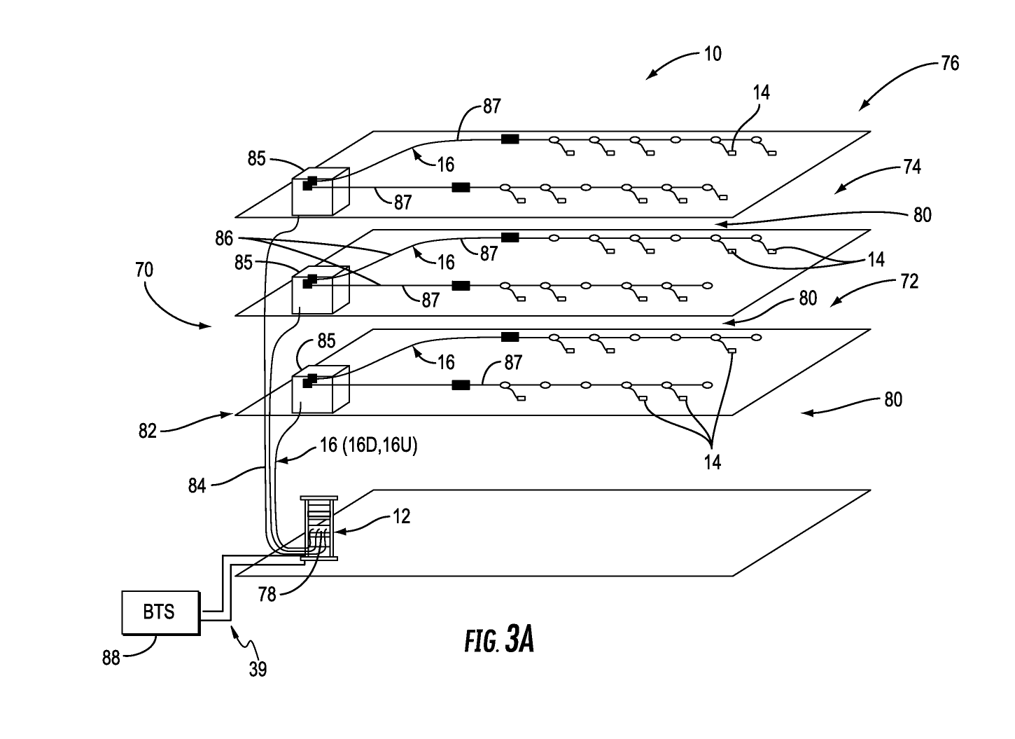

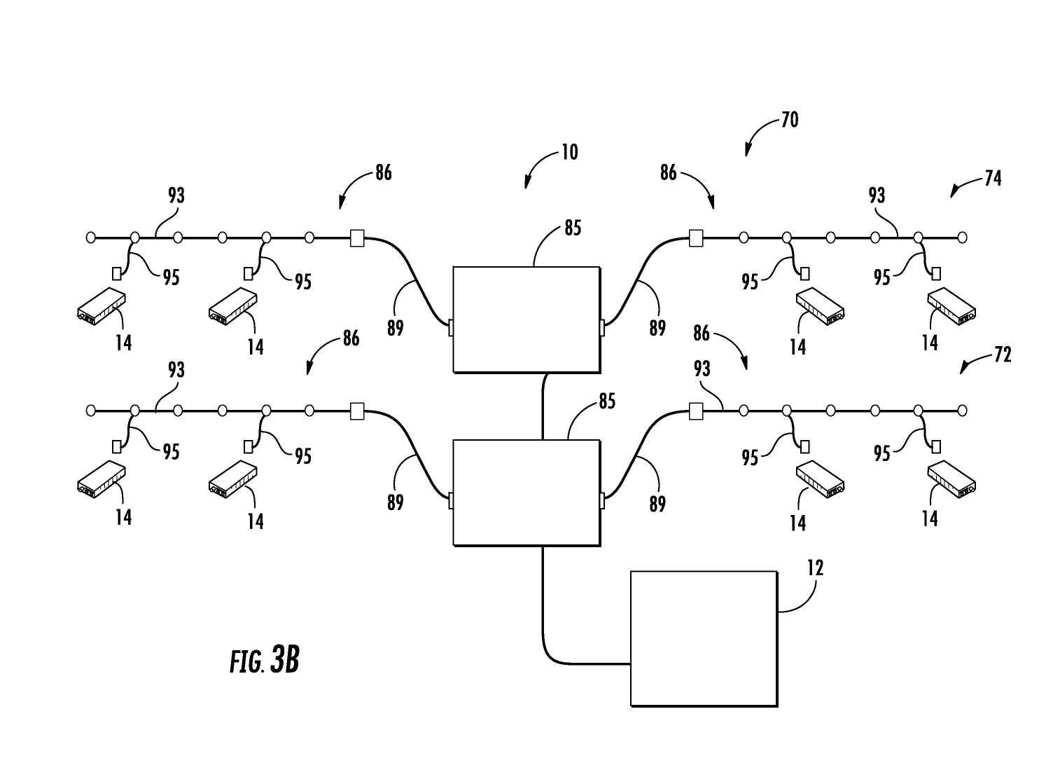

To provide further exemplary illustration of how the distributed antenna system 10 can be deployed indoors, FIG. 3A is provided. FIG. 3A is a partially schematic cut-away diagram of a building infrastructure 70 employing the distributed antenna system 10. The building infrastructure 70 generally represents any type of building in which the distributed antenna system 10 can be deployed. As previously discussed with regard to FIGS. 1 and 2, the distributed antenna system 10 incorporates the HEE 12 to provide various types of communication services to coverage areas within the building infrastructure 70, as an example.

For example, as discussed in more detail below, the distributed antenna system 10 in this embodiment is configured to receive wireless RF signals and convert the RF signals into RoF signals to be communicated over the optical fiber 16 to multiple RAUs 14. The distributed antenna system 10 in this embodiment can be, for example, an indoor distributed antenna system (IDAS) to provide wireless service inside the building infrastructure 70. These wireless signals can include cellular service, wireless services such as RFID tracking, Wireless Fidelity (WiFi), local area network (LAN), WLAN, public safety, wireless building automations, and combinations thereof, as examples.

With continuing reference to FIG. 3A, the building infrastructure 70 in this embodiment includes a first (ground) floor 72, a second floor 74, and a third floor 76. The floors 72, 74, 76 are serviced by the HEE 12 through a main distribution frame 78 to provide antenna coverage areas 80 in the building infrastructure 70. Only the ceilings of the floors 72, 74, 76 are shown in FIG. 3A for simplicity of illustration. In the example embodiment, a main cable 82 has a number of different sections that facilitate the placement of a large number of RAUs 14 in the building infrastructure 70. Each RAU 14 in turn services its own coverage area in the antenna coverage areas 80. The main cable 82 can include, for example, a riser cable 84 that carries all of the downlink and uplink optical fibers 16D, 16U to and from the HEE 12. The riser cable 84 may be routed through an interconnect unit (ICU) 85. The ICU 85 may be provided as part of or separate from the power supply 54 in FIG. 2. The ICU 85 may also be configured to provide power to the RAUs 14 via the electrical power line 58, as illustrated in FIG. 2 and discussed above, provided inside an array cable 87, or tail cable or home-run tether cable as other examples, and distributed with the downlink and uplink optical fibers 16D, 16U to the RAUs 14. For example, as illustrated in the building infrastructure 70 in FIG. 3B, a tail cable 89 may extend from the ICUs 85 into an array cable 93. Downlink and uplink optical fibers 16D, 16U in tether cables 95 of the array cables 93 are routed to each of the RAUs 14, as illustrated in FIG. 3B. The main cable 82 can include one or more multi-cable (MC) connectors adapted to connect select downlink and uplink optical fibers 16D, 16U, along with an electrical power line, to a number of optical fiber cables 86.

The main cable 82 enables multiple optical fiber cables 86 to be distributed throughout the building infrastructure 70 (e.g., fixed to the ceilings or other support surfaces of each floor 72, 74, 76) to provide the antenna coverage areas 80 for the first, second, and third floors 72, 74, and 76. In an example embodiment, the HEE 12 is located within the building infrastructure 70 (e.g., in a closet or control room), while in another example embodiment, the HEE 12 may be located outside of the building infrastructure 70 at a remote location. A base transceiver station (BTS) 38, which may be provided by a second party such as a cellular service provider, is connected to the HEE 12, and can be co-located or located remotely from the HEE 12. A BTS is any station or signal source that provides an input signal to the HEE 12 and can receive a return signal from the HEE 12.

In a typical cellular system, for example, a plurality of BTSs are deployed at a plurality of remote locations to provide wireless telephone coverage. Each BTS serves a corresponding cell and when a mobile client device enters the cell, the BTS communicates with the mobile client device. Each BTS can include at least one radio transceiver for enabling communication with one or more subscriber units operating within the associated cell. As another example, wireless repeaters or bi-directional amplifiers could also be used to serve a corresponding cell in lieu of a BTS. Alternatively, radio input could be provided by a repeater, picocell, or femtocell as other examples.

The distributed antenna system 10 in FIGS. 1-3B and described above provides point-to-point communications between the HEE 12 and the RAU 14. A multi-point architecture is also possible as well. With regard to FIGS. 1-3B, each RAU 14 communicates with the HEE 12 over a distinct downlink and uplink optical fiber pair to provide the point-to-point communications. Whenever an RAU 14 is installed in the distributed antenna system 10, the RAU 14 is connected to a distinct downlink and uplink optical fiber pair connected to the HEE 12. The downlink and uplink optical fibers 16D, 16U may be provided in a fiber optic cable. Multiple downlink and uplink optical fiber pairs can be provided in a fiber optic cable to service multiple RAUs 14 from a common fiber optic cable.

For example, with reference to FIG. 3A, RAUs 14 installed on a given floor 72, 74, or 76 may be serviced from the same optical fiber 16. In this regard, the optical fiber 16 may have multiple nodes where distinct downlink and uplink optical fiber pairs can be connected to a given RAU 14. One downlink optical fiber 16D could be provided to support multiple channels each using wavelength-division multiplexing (WDM), as discussed in U.S. patent application Ser. No. 12/892,424 entitled “Providing Digital Data Services in Optical Fiber-based Distributed Radio Frequency (RF) Communications Systems, And Related Components and Methods,” incorporated herein by reference in its entirety. Other options for WDM and frequency-division multiplexing (FDM) are also disclosed in U.S. patent application Ser. No. 12/892,424, any of which can be employed in any of the embodiments disclosed herein.

The HEE 12 may be configured to support any frequencies desired, including but not limited to US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink).

It may be desired or required to provide localization services for client devices 24 in distributed antenna system 10 in FIGS. 1-3B. One application where determining the location of client devices 24 is desired or required is emergency 911 (E911) services. Another example where determining location of client devices 24 may be desired is to provide targeted or contextual information, such as advertisements, to the client devices 24 based on their location. However, it may be difficult or not possible to determine the location of the client devices 24 in the distributed antenna systems 10. For example, it may not be possible to use global positioning services (GPSs) to determine the location of the client devices 24 due to blockage or attenuation of the GPS signals in the environment of the distributed antenna system 10. Further, triangulation or other techniques from the outside network may not be able to determine the location of the client devices 24 in the environment of the distributed antenna systems 10.

One method to determine with which particular RAU 14 within the distributed antenna system 10 a client device 24 is communicating is to uniquely identify the RAU 14 communication with the client device 24. The exemplary distributed antenna system 10 described above in FIGS. 1-3B includes natural signal propagation delay between the HEE 12 and the RAUs 14. The signal propagation delay is influenced by the intervening communications components, the communication medium (i.e., downlink and uplink optical fiber 16D, 16U) between the HEE 12 and the RAUs 14, and the distance between the HEE 12 and the RAUs 14. The distances between different RAUs 14 and the HEE 12 may not be significantly different to determine differences in distances between different RAUs 14 and the HEE 12. Further, some RAUs 14 may be located the same or substantially the same distance from the HEE 12, but still in different locations.

In this regard, FIG. 4 is a modified distributed antenna system 10′ that includes different additional signal propagation delays (“additional propagation delay”) in the communication paths of the downlink and uplink optical fiber 16D, 16U for some or all of the RAUs 14 and the HEE 12. As will be described in more detail below, the additional propagation delay is pre-configured to correspond to a particular RAU 14 in the distributed antenna system 10′ and its location. Then, during communications sessions with client devices 24, a determination is made with which RAU 14, a client device 24 is communicating. This determination can be made by correlating the propagation delay of communication signals 22D, 22U from the client device 24 with propagation delays pre-configured for the RAUs 14. The identification of the RAU 14 can then in turn be correlated to a previously configured location of the RAU 14 within the distributed antenna system 10′. The location of the RAU 14 is an indication of the location or location range of the client device 24 communication with the RAU 14. The client device 24, by communicating with an identified RAU 14, is known to be within the communication range of the identified RAU 14. After the propagation delay is correlated to location of the RAU 14 to determine the location of the client device 24, other systems or components may then provide or facilitate signal propagation delay equalization for the communication session with the client device.

As illustrated in FIG. 4, a plurality of RAUs 14(1)-14(N) are provided in the distributed antenna system 10′. Each of the RAUs 14(1)-14(N) are communicatively coupled to the HEE 12. In this regard, a downlink optical fiber 16D(1)-16D(N) is provided between each RAU 14(1)-14(N) and the HEE 12 to provide downlink communication paths to distribute downlink communications signals 22D(1)-22D(N) for downlink communications. The notation “1-N” signifies that any number up to N number of RAUs 14 may be provided in the distributed antenna system 10′. An uplink optical fiber 16U(1)-16U(N) is provided between each RAU 14(1)-14(N) and the HEE 12 to provide uplink communication paths to distribute uplink communications signals 22U(1)-22U(N) for uplink communications. Client devices 24(1)-24(X) can travel through the distributed antenna system 10′ and establish communication sessions through communications with the distributed RAUs 14(1)-14(N), as previously described above. The notation “1-X” signifies that any number up to X number of client device 24 may be located in the distributed antenna system 10′ and communicate with the RAUs 14(1)-14(N).

With continuing reference to FIG. 4, additional delay components 100(1)-100(N) are introduced into each of the downlink and uplink communication paths of the distributed antenna system 10′ to add additional signal propagation delay to the downlink and uplink communications signals 22D(1-N), 22U(1-N) to allow communication signals to be uniquely identified with a particular RAU 14(1)-14(N). As will be discussed in more detail below, the delay components 100(1)-100(N) are configured so that the propagation delay for communications between the RAUs 14(1)-14(N) and the HEE 12 can be uniquely distinguished so that the RAUs 14(1)-14(N) can be distinguished from each other. The propagation delays and locations of the RAUs 14(1)-14(N) are preconfigured in a database 102 during installation, setup, and/or maintenance of the distributed antenna system 10′ so that a lookup can be performed to correlate determined propagation delay from communications to a specific RAU 14, and in turn a location of a RAU 14. A location server 104 may be provided that is accessible by either the BTS 38 and/or the HEE 12 to perform the lookup in the database 102 to correlate determined propagation delay from communications to a specific RAU 14. The BTS 38 may be communicatively coupled to a network 41 that provides the downlink communications signals 22D(1)-22D(N) distributed by the BTS 38 in the distributed antenna system 10′ and receive return uplink communication signals 22U(1)-22U(N) from the client devices 24(1)-24(X) in the distributed antenna system 10′.

As non-limiting examples, the delay components 100(1)-100(N) could be additional lengths of communication medium, which in this example would be additional lengths of optical fiber. If other communication medium is employed in the distributed antenna system 10′, additional lengths of other communication medium can be employed. Other types of delay components 100(1)-100(N) other than additional lengths of communications medium may be employed to provide additional propagation delay. For example, delay circuits may be provided as the delay components 100(1)-100(N). For example, a series or network of amplifiers configured in voltage following modes could be employed to provide additional delay. If the downlink and uplink communications signals 22D(1)-22D(N), 22U(1)-22U(N) are digitized, the delay components 100(1)-100(N) may be buffer circuits as an example.

With continuing reference to FIG. 4, both downlink delay components 100D(1)-100D(N) and uplink delay components 100U(1)-100U(N) are introduced in the downlink and uplink communications paths, respectively, in this example. Additional propagation delay could be provided in either the downlink communications paths or the uplink communications paths if desired. However, providing additional propagation delay in both the downlink communications paths and the uplink communications paths balances the additional propagation delay between the downlink communications signals 22D(1)-22(N) and uplink communications signals 22U(1)-22U(N). Thus, the additional propagation delay desired to be provided for the RAUs 14(1)-14(N) may be cut in half and split between a downlink delay component 100D(1)-100D(N) and the corresponding uplink delay component 100U(1)-100U(N).

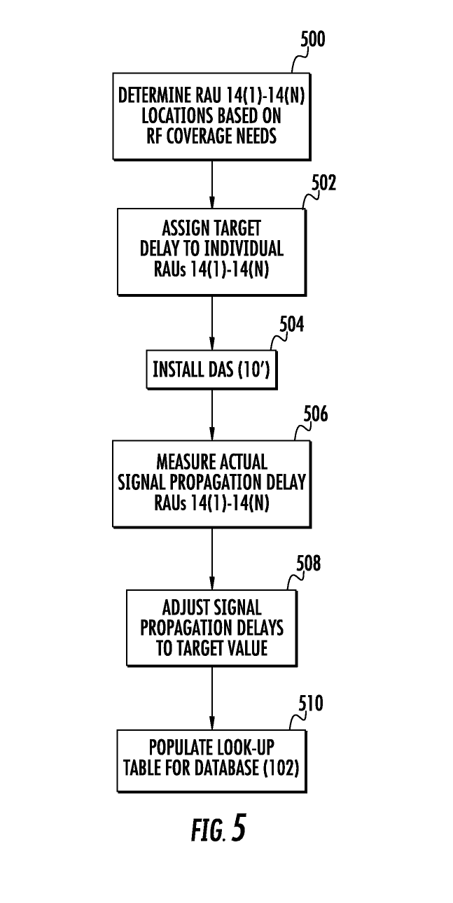

As discussed above, the additional propagation delays for the RAUs 14(1)-14(N) are determined and provided through the delay components 100(1)-100(N) to uniquely identify the RAUs 14(1)-14(N). The resulting propagation delay of communications with the RAUs 14(1)-14(N) from the additional propagation delays provided by the presence of the delay components 100(1)-100(N) are configured in the database 102. The database 102 can then be consulted for received uplink communication signals 22U from client devices 24 to be used to identify the particular RAUs 14(1)-14(N) the client device 24 is communicating with, and in turn the location of the RAU 14(1)-14(N) and client device 24. In this regard, FIG. 5 is a flowchart illustrating an exemplary process of providing additional propagation delays for RAUs 14(1)-14(N) in the distributed antenna system 10′. The exemplary process in FIG. 5 also provides configuring the database 102 with the resulting measured propagation delays of the RAUs 14(1)-14(N) to uniquely identify the RAUs 14(1)-14(N) for correlation to location of client devices 24 communication with the RAUs 14(1)-14(N) in the distributed antenna system 10′.

With reference to FIG. 5, the locations of the RAUs 14(1)-14(N) in the distributed antenna system 10′ are determined based on the RF coverage needs for the distributed antenna system 10′ (block 500). Target propagation delays are then assigned to the individual RAUs 14(1)-14(N) so that the RAUs 14(1)-14(N) can be distinguished from each other based on communication with the RAUs 14(1)-14(N) (block 502). The target propagation delays are provided for the RAUs 14(1)-14(N) by providing additional propagation delay via the delay components 100(1)-100(N) (block 502). Not all RAUs 14(1)-14(N) have to be assigned additional propagation delay. For example, one RAU 14 may have a natural propagation delay that is distinguishable from the other propagation delays for other RAUs 14 based on the additional propagation delays provided for the other RAUs 14. The additional propagation delays are selected to provide a total propagation delay based on the targeted propagation delay for the RAUs 14(1)-14(N). The distributed antenna system 10′ is then installed with the delay components 100(1)-100(N) installed for the RAUs 14(1)-14(N) (block 504).

With continuing reference to FIG. 5, after the distributed antenna system 10′ is installed (block 504), the actual total propagation delay for communication signals with each RAU 14(1)-14(N) is measured. The actual propagation delay is measured so that the database 102 can be populated with the different propagation delays correlated to identification of individual RAUs 14(1)-14(N) (block 506). The differences in total propagation delay is a function of not only the delay components 100(1)-100(N), but the communication medium, the distance between the RAU 14(1)-14(N) and the HEE 12, the distance between the HEE 12 and the BTS 38, and the communications components in the communication paths to and from the RAUs 14(1)-14(N). The delay components 100(1)-100(N) provide additional propagation delay since the granularity of differences between other sources of propagation delay for each of the RAUs 14(1)-14(N) may not be significant enough to distinguish communications between different RAUs 14(1)-14(N). If the actual propagation delay between different RAUs 14(1)-14(N) is not different enough to be able to distinguish the RAU 14(1)-14(N), the delay component 100(1)-100(N) for those RAUs 14(1)-14(N) may be adjusted (block 508).

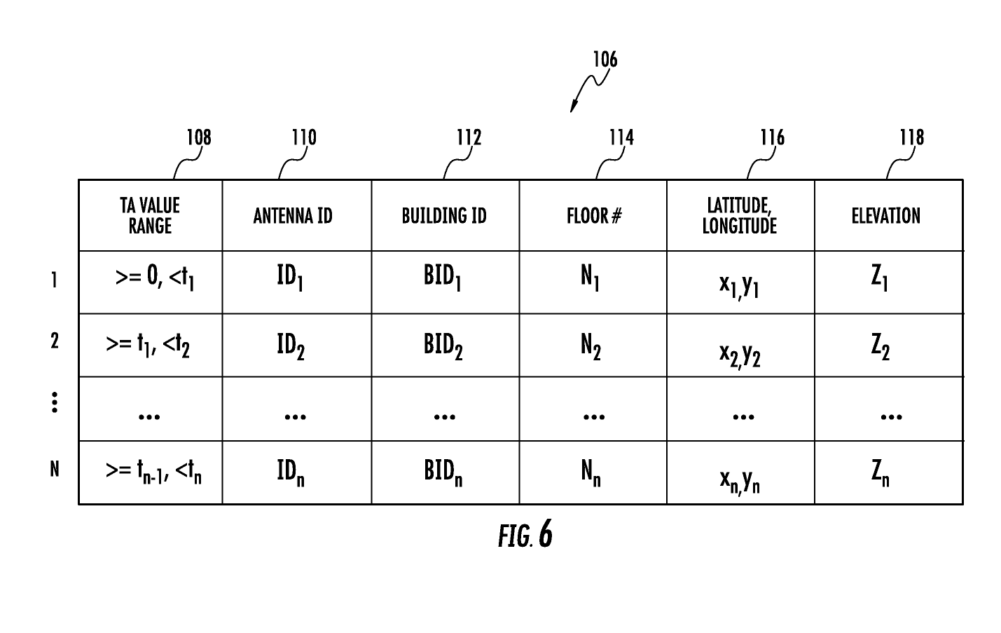

With continuing reference to FIG. 5, after any additional propagation delays are adjusted, a look-up table in the database 102 is populated to identify the RAUs 14(1)-14(N) as a function of actual propagation delay (block 510) along with the installed location of the RAUs 14(1)-14(N). In this regard, FIG. 6 is an exemplary look-up table 106 that may be stored in the database 102 to associate actual propagation delay with the identity of a RAU 14(1)-14(N) and a corresponding location. In this manner, when communications are established with client devices 24, the actual propagation delay of the communication signals 22 with the client devices 24 can be reviewed and compared to the entries in the look-up table 106 to identify the RAU 14(1)-14(N) involved in the communications. Identifying the RAU 14(1)-14(N) involved in communications with a client device 24 allows the determination that the location of the client device 24 is within the communication range of the identified RAU 14(1)-14(N).

As illustrated in FIG. 6, the look-up table 106 contains a number of entries to correlate actual propagation delay to the identity and location of the RAUs 14(1)-14(N) in the distributed antenna system 10′ to determine location of client devices 24(1)-24(X). Because there are N number of RAUs 14(1)-14(N) in the distributed antenna system 10′, there are N entries rows in the look-up table 106 in FIG. 6. For each RAU 14(1)-14(N) entry in the look-up table 106, an actual propagation delay column 108 is provided that contains ranges of actual propagation delays that were configured for each of the RAUs 14(1)-14(N) in the distributed antenna system 10′ in FIG. 5. The actual propagation delays are ideally configured to be non-overlapping so that each of the RAUs 14(1)-14(N) can be uniquely identified based on the actual propagation delay involving communications with the RAUs 14(1)-14(N). For example, the first actual propagation entry is >=0<t₁, wherein t₁ is an actual propagation delay value that was determined during configuration in FIG. 5. If communication signals have an actual propagation delay in this range, this means that RAU 14 having the antenna identification ID₁ in an antenna ID column 110 is involved in the communications.

With continuing reference to FIG. 6, during configuration of the look-up table 106, the location of each RAU 14(1)-14(N) is provided in additional columns that correspond to the identification of the RAUs 14(1)-14(N). In the example of the look-up table 106 in FIG. 6, the location is provided as a series of data, which includes a building identification (e.g., BID₁) in a building ID column 112, a floor number (e.g., N₁) in the building provided in a floor # column 114, a latitude and longitude pair (e.g., x₁, y₁) provided in a latitude, longitude column 116, and an elevation (e.g., Z₁) provided in an elevation column 118.

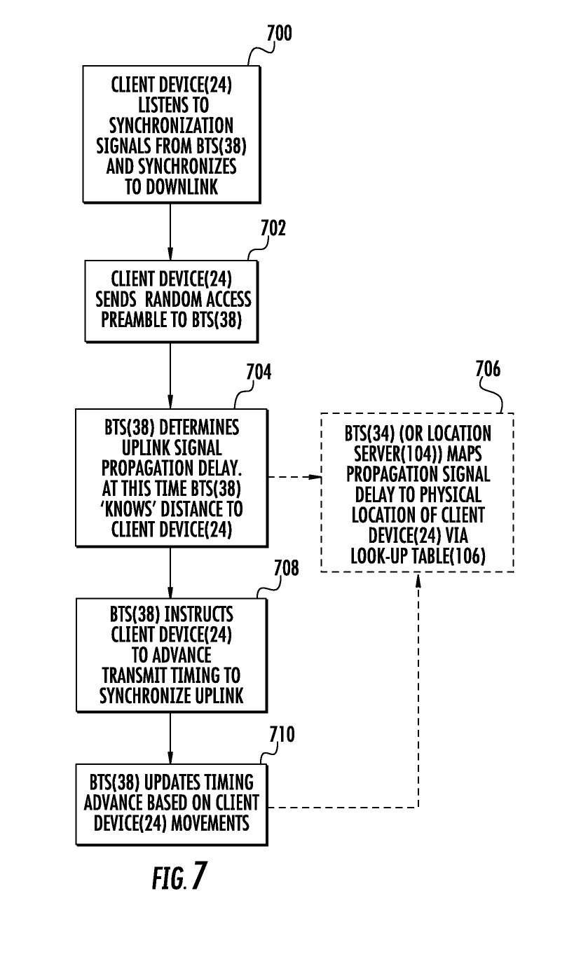

Once the look-up table 106 is configured in this example, the distributed antenna system 10′ is configured to allow determination of client devices 24(1)-24(X) communicating with RAUs 14(1)-14(N) in the distributed antenna system 10′. In this regard, FIG. 7 is a flowchart illustrating an exemplary process of establishing a communication session with a client device 24(1)-24(X) in the distributed antenna system 10′ using long term evolution (LTE) protocol as example. Note however, that this process is not limited to LTE protocol client devices 24. The process also involves mapping actual propagation delay of communications signals involving the client device 24(1)-24(X) to the identification and location of a RAU 14(1)-14(N) communicating with the client device 24(1)-24(X). The location of the client device 24(1)-24(X) is known to be within the communication range of the RAU 14(1)-14(N) identified as involved with communications with the client device 24(1)-24(X). This technique of determining location by mapping actual propagation delay with additional propagation delay added to communications paths can be employed with any communication technology standard or protocol desired.

With reference to FIG. 7, when a client device 24(1)-24(X) establishes a communication session with a RAU 14(1)-14(N) in the distributed antenna system 10′, the client device 24(1)-24(X) listens to synchronization signals from the BTS 38 from the downlink communications path (block 700). The client device 24(1)-24(X) synchronizes to the downlink communication path based on receipt of the synchronization signals (block 700). The client device 24(1)-24(X) sends a random access preamble to the BTS 38 over the uplink communications path (block 702). The BTS 38 then determines the actual propagation delay from the uplink communications signal 22U(1)-22U(N) received from the client device 24(1)-24(X). The BTS 38 or the location server 104 can determine the distance to the client device 24(1)-24(X) from the actual propagation delay (block 704). In this regard as previously discussed, the BTS 38 or the location server 104 can perform a request to the look-up table 106 to determine the physical location of the client device 24(1)-24(X) based on the actual propagation delay (block 706). The location can be used for any purpose application desired. For example, the BTS 38 could provide the location of the client device 24(1)-24(X) over the network 41.

With continuing reference to FIG. 7, before the location of the client device 24(1)-24(X) is determined, the BTS 38 instructs the client device 24(1)-24(X) to advance its transmit timing to synchronize uplink communication signals 22U(1)-22U(N) (block 708). For example, the BTS 38 may be configured to synchronize the uplink communication signals 22U(1)-22U(N) for all client devices 24(1)-24(X) communicating with RAUs 14(1)-14(N) in the distributed antenna system 10′ depending on the communication standard employed. Thereafter, the BTS 38 updates the timing advance based on the client device 24(1)-24(X) movements throughout the distributed antenna system 10′ (block 710). The location of the client device 24(1)-24(X) can be determined or determined again if the client device 24(1)-24(X) moves based on the change in the actual propagation delay (block 706).

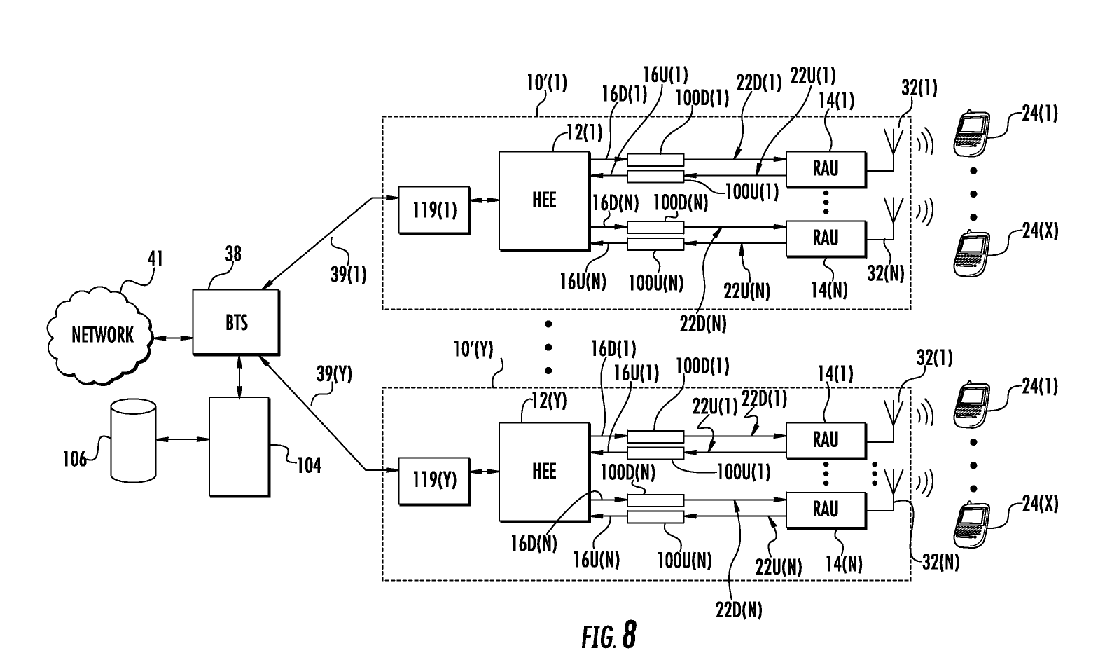

The techniques to determine the location of client devices 24(1)-24(X) can also be provided where multiple distributed antenna systems 10′ are communicatively coupled to the BTS 38. In this regard, FIG. 8 is a schematic diagram illustrating a plurality of the distributed antenna systems 10′(1)-10′(Y) in FIG. 4. The notation “1-Y” signifies that any number, Y number, of distributed antenna systems 10′ can be coupled to the BTS 38. Components in the distributed antenna systems 10′(1)-10′(Y) containing the same element numbers in FIG. 8 are as previously described. If the additional propagation delays are provided through only the delay components 100(1)-100(N), the BTS 38 is able to uniquely distinguish RAUs 14(1)-14(N) within the same distributed antenna system 10′(1)-10′(Y), but may not be able to distinguish between RAUs 14(1)-14(N) between different distributed antenna systems 10′(1)-10′(Y). For example, two RAUs 14 in the different distributed antenna systems 10′(1)-10′(Y) may be configured with the same additional propagation delay and may have the same or substantially the same actual propagation delay.

In this regard, FIG. 8 provides additional delay components 119(1)-119(Y) for each of the distributed antenna systems 10′(1)-10′(Y). The additional delay components 119(1)-119(Y) can be selected from any delay components desired, including those described above as examples for the delay components 100(1)-100(N). The additional delay components 119(1)-119(Y) may be disposed between the BTS 38 and the HEEs 12(1)-12(Y). In this manner, the additional delay components 119(1)-119(Y) can be configured with different delays to be additive to the actual propagation delays for communications in the distributed antenna systems 10′(1)-10′(Y). Thus, the actual propagation delays between the different distributed antenna systems 10′(1)-10′(Y) can be configured to be non-overlapping so that the BTS 38 can distinguish between different distributed antenna systems 10′(1)-10′(Y) for determining location of client devices 24(1)-24(X). The same configuration process illustrated in FIG. 5 and discussed above can be employed to configure the actual propagation delays for the distributed antenna systems 10′(1)-10′(Y). The look-up table 106 in FIG. 6 can be configured to provide a third dimension or additional column to additionally identify the distributed antenna system 10′(1)-10′(Y) for each RAU 14(1)-14(N). The process illustrated in FIG. 7 can be employed to determine the location of client devices 24(1)-(X) within any of the distributed antenna systems 10′(1)-10′(Y) in FIG. 8.

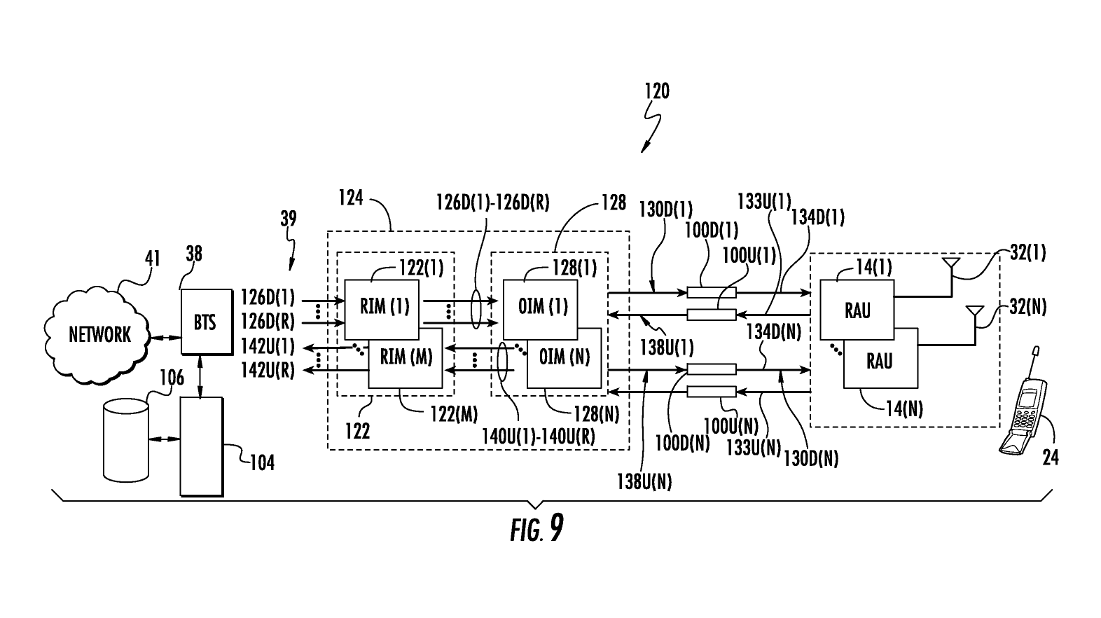

The additional propagation delay provided to communication paths of the RAUs 14(1)-14(N) in the distributed antenna systems 10′ described above can also be provided in other types of distributed antenna systems. For example, FIG. 9 is a schematic diagram of another exemplary distributed antenna system 120 that may be employed according to the embodiments disclosed herein to provide location services for client devices. In this embodiment, the distributed antenna system 120 is an optical fiber-based distributed antenna system. The distributed antenna system 120 includes optical fiber for distributing RF communication services. The distributed antenna system 120 in this embodiment is comprised of three (3) main components. One or more radio interfaces provided in the form of radio interface modules (RIMs) 122(1)-122(M) in this embodiment are provided in HEE 124 to receive and process downlink electrical RF communications signals 126D(1)-126D(R) prior to optical conversion into downlink optical RF communications signals. The RIMs 122(1)-122(M) provide both downlink and uplink interfaces. The processing of the downlink electrical RF communications signals 126D(1)-126D(R) can include any of the processing previously described above in the HEE 12. The notations “1-R” and “1-M” indicate that any number of the referenced component, 1-R and 1-M, respectively, may be provided. As will be described in more detail below, the HEE 124 is configured to accept a plurality of RIMs 122(1)-122(M) as modular components that can easily be installed and removed or replaced in the HEE 124. In one embodiment, the HEE 124 is configured to support up to eight (8) RIMs 122(1)-122(M).

Each RIM 122(1)-122(M) can be designed to support a particular type of radio source or range of radio sources (i.e., frequencies) to provide flexibility in configuring the HEE 124 and the distributed antenna system 120 to support the desired radio sources. For example, one RIM 122 may be configured to support the Personal Communication Services (PCS) radio band. Another RIM 122 may be configured to support the 700 MHz radio band. In this example, by inclusion of these RIMs 122, the HEE 124 would be configured to support and distribute RF communications signals on both PCS and LTE 700 radio bands. RIMs 122 may be provided in the HEE 124 that support any frequency bands desired, including but not limited to the US Cellular band, Personal Communication Services (PCS) band, Advanced Wireless Services (AWS) band, 700 MHz band, Global System for Mobile communications (GSM) 900, GSM 1800, and Universal Mobile Telecommunication System (UMTS). RIMs 122 may be provided in the HEE 124 that support any wireless technologies desired, including but not limited to Code Division Multiple Access (CDMA), CDMA200, 1xRTT, Evolution—Data Only (EV-DO), UMTS, High-speed Packet Access (HSPA), GSM, General Packet Radio Services (GPRS), Enhanced Data GSM Environment (EDGE), Time Division Multiple Access (TDMA), Long Term Evolution (LTE), iDEN, and Cellular Digital Packet Data (CDPD).

RIMs 122 may be provided in the HEE 124 that support any frequencies desired, including but not limited to US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink).

The downlink electrical RF communications signals 126D(1)-126D(R) are provided to a plurality of optical interfaces provided in the form of optical interface modules (OIMs) 128(1)-128(N) in this embodiment to convert the downlink electrical RF communications signals 126D(1)-126D(R) into downlink optical RF communications signals 130D(1)-130D(N). The notation “1-N” indicates that any number of the referenced component 1-N may be provided. The OIMs 128 may be configured to provide one or more optical interface components (OICs) that contain O/E and E/O converters, as will be described in more detail below. The OIMs 128 support the radio bands that can be provided by the RIMs 122, including the examples previously described above. Thus, in this embodiment, the OIMs 128 may support a radio band range from 400 MHz to 2700 MHz, as an example, so providing different types or models of OIMs 128 for narrower radio bands to support possibilities for different radio band-supported RIMs 122 provided in the HEE 124 is not required. Further, as an example, the OIMs 128 may be optimized for sub-bands within the 400 MHz to 2700 MHz frequency range, such as 400-700 MHz, 700 MHz-1 GHz, 1 GHz-1.6 GHz, and 1.6 GHz-2.7 GHz, as examples.

The OIMs 128(1)-128(N) each include E/O converters to convert the downlink electrical RF communications signals 126D(1)-126D(R) to downlink optical RF communications signals 130D(1)-130D(N). The downlink optical RF communications signals 130D(1)-130D(N) are communicated over downlink optical fiber(s) 133D(1) to a plurality of RAUs 14(1)-14(N). O/E converters provided in the RAUs 14(1)-14(N) convert the downlink optical RF communications signals 130D(1)-130D(N) back into downlink electrical RF communications signals 126D(1)-126D(R), which are provided over downlinks 134D(1)-134D(N) coupled to antennas 32(1)-32(N) in the RAUs 14(1)-14(N) to client devices in the reception range of the antennas 32(1)-32(N).

E/O converters are also provided in the RAUs 14(1)-14(N) to convert uplink electrical RF communications signals received from client devices through the antennas 32(1)-32(N) into uplink optical RF communications signals 138U(1)-138U(N) to be communicated over uplink optical fibers 133U(1)-133U(N) to the OIMs 128(1)-128(N). The OIMs 128(1)-128(N) include O/E converters that convert the uplink optical RF communications signals 138U(1)-138U(N) into uplink electrical RF communications signals 140U(1)-140U(R) that are processed by the RIMs 122(1)-122(M) and provided as uplink electrical RF communications signals 142U(1)-142U(R).

In one embodiment, up to thirty-six (36) RAUs 14(1)-14(N) can be supported by the OIMs 128, three RAUs 14 per OIM 128 in the distributed antenna system 120 in FIG. 9. The distributed antenna system 120 is scalable to address larger deployments. In the illustrated distributed antenna system 120, the HEE 124 is configured to support up to thirty six (36) RAUs 14(1)-14(N) and fit in 6 U rack space (U unit meaning 1.75 inches of height). The downlink operational input power level can be in the range of −15 dBm to 33 dBm. The adjustable uplink system gain range can be in the range of +15 dB to −15 dB. The RF input interface in the RIMs 122 can be duplexed and simplex, N-Type. The distributed antenna system 120 could include sectorization switches to be configurable for sectorization capability, as discussed in U.S. patent application Ser. No. 12/914,585 filed on Oct. 28, 2010, and entitled “Sectorization In Distributed Antenna Systems, and Related Components and Method,” which is incorporated herein by reference in its entirety.

In another embodiment, the RAUs 14(1)-14(N) may be configured to support up to four (4) different radio bands/carriers (e.g. ATT, VZW, TMobile, Metro PCS: 700LTE/850/1900/2100). Radio band upgrades can be supported by adding remote expansion units over the same optical fiber, as described in PCT Application No. PCT/US11/43405 filed Jul. 8, 2011 and entitled “Optical Fiber-based Distributed Radio Frequency (RF) Antenna Systems Supporting Multiple-Input, Multiple-Output (MIMO) Configurations, and Related Components and Methods,” which is incorporated herein by reference in its entirety. The RAUs 14(1)-14(N) may be configured to provide external filter interface to mitigate potential strong interference at 700 MHz band (Public Safety, CH51,56); Single Antenna Port (N-type) provides DL output power per band (Low bands (<1 GHz): 14 dBm, High bands (>1 GHz): 15 dBm); and satisfies the UL System RF spec (UL Noise Figure: 12 dB, UL IIP3: −5 dBm, UL AGC: 25 dB range).

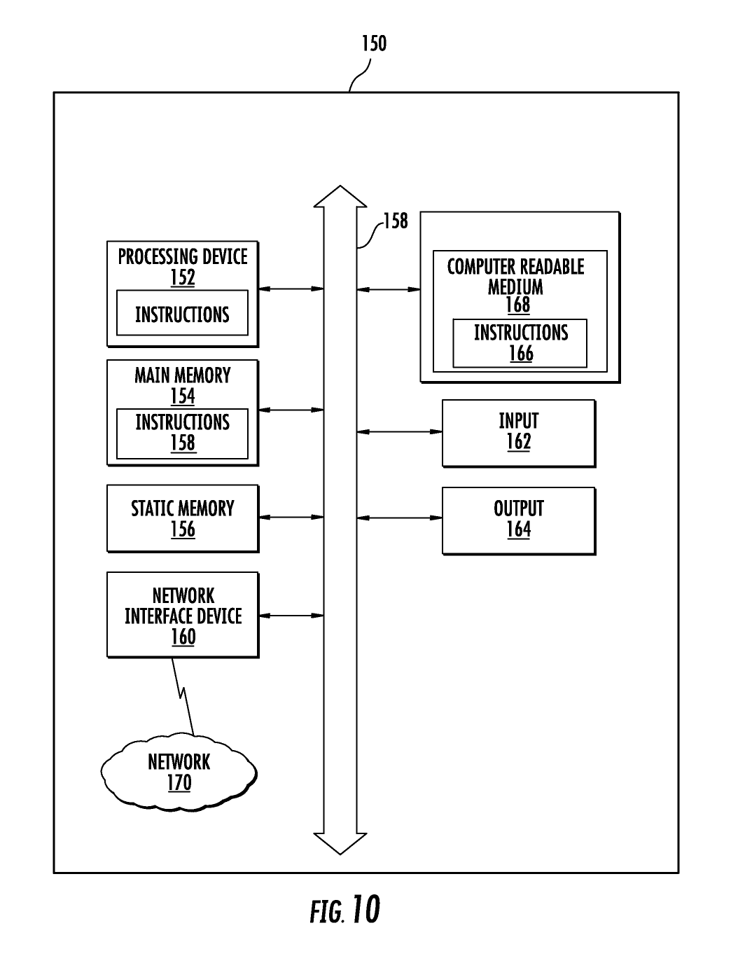

FIG. 10 is a schematic diagram representation of additional detail regarding an exemplary computer system 150 adapted to execute instructions from an exemplary computer-readable medium to perform the location services described herein. The computer system 150 may be the location server 104 in FIGS. 4 and 8 as an example. The computer system 150 may also be located within the BTS 38 in FIGS. 4 and 8. As previously discussed, the BTS 38 or the location server 104 may perform the processes illustrated in FIGS. 5 and 7 and described above. In this regard, the BTS 38 or location server 104 may include the computer system 150 within which a set of instructions for performing any one or more of the location services discussed herein may be executed. The computer system 150 may be connected (e.g., networked) to other machines in a LAN, an intranet, an extranet, or the Internet. The computer system 150 may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The computer system 150 may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server or a user's computer.

The exemplary computer system 150 in this embodiment includes a processing device or processor 152, a main memory 154 (e.g., read-only memory (ROM), flash memory, dynamic random access memory (DRAM) such as synchronous DRAM (SDRAM), etc.), and a static memory 156 (e.g., flash memory, static random access memory (SRAM), etc.), which may communicate with each other via the data bus 158. Alternatively, the processing device 152 may be connected to the main memory 154 and/or static memory 156 directly or via some other connectivity means. The processing device 152 may be a controller, and the main memory 154 or static memory 156 may be any type of memory.

The processing device 152 represents one or more general-purpose processing devices such as a microprocessor, central processing unit, or the like. More particularly, the processing device 152 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 152 is configured to execute processing logic in instructions 159 for performing the operations and steps discussed herein.

The computer system 150 may further include a network interface device 160. The computer system 150 also may or may not include an input 162 to receive input and selections to be communicated to the computer system 150 when executing instructions. The computer system 150 also may or may not include an output 164, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 150 may or may not include a data storage device that includes instructions 166 stored in a computer-readable medium 168. The instructions 166 may also reside, completely or at least partially, within the main memory 154 and/or within the processing device 152 during execution thereof by the computer system 150, the main memory 154 and the processing device 152 also constituting computer-readable medium. The instructions 166 may further be transmitted or received over a network 170 via the network interface device 160.

While the computer-readable medium 168 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical and magnetic medium, and carrier wave signals.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.), a machine-readable transmission medium (electrical, optical, acoustical, or other form of propagated signals (e.g., carrier waves, infrared signals, digital signals, etc.)), etc.

Unless specifically stated otherwise as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals. An example of a bend-insensitive, or bend resistant, optical fiber is ClearCurve®Multimode fiber commercially available from Corning Incorporated. Suitable fibers of this type are disclosed, for example, in U.S. Patent Application Publication Nos. 2008/0166094 and 2009/0169163, the disclosures of which are incorporated herein by reference in their entireties.

Many modifications and other embodiments of the embodiments set forth herein will come to mind to one skilled in the art to which the embodiments pertain having the benefit of the teachings presented in the foregoing descriptions and the associated drawings. For example, the distributed antenna systems could include any type or number of communications mediums, including but not limited to electrical conductors, optical fiber, and air (i.e., wireless transmission). The distributed antenna systems may distribute any type of communications signals, including but not limited to RF communications signals and digital data communications signals, examples of which are described in U.S. patent application Ser. No. 12/892,424 entitled “Providing Digital Data Services in Optical Fiber-based Distributed Radio Frequency (RF) Communications Systems, And Related Components and Methods,” incorporated herein by reference in its entirety. Multiplexing, such as WDM and/or FDM, may be employed in any of the distributed antenna systems described herein, such as according to the examples provided in U.S. patent application Ser. No. 12/892,424.

Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

We claim:

1. A distributed antenna system, comprising:
a plurality of remote antenna units (RAU) each configured to communicate received downlink radio-frequency (RF) communications signals wirelessly to client devices and configured to receive uplink RF communications signals wirelessly from the client devices;
head end equipment (HEE) configured to:
receive the downlink RF communications signals from a base station and distribute the received downlink communication RF signals over a plurality of downlink communications paths comprising a plurality of downlink communications medium each coupled to one of the plurality of remote antenna units (RAUs); and
receive uplink RF communications signals over a plurality of uplink communications paths comprising a plurality of uplink communications medium each coupled to one of the plurality of RAUs; and
at least one of additional uplink delay component provided in one or more of the uplink communications paths to increase a signal propagation delay of the uplink RF communications signals such that each of the plurality of uplink communications paths has a unique actual signal propagation delay to uniquely identify the plurality of RAUs from the actual signal propagation delay of the uplink RF communications signals.

2. The distributed antenna system of claim 1, wherein the at least one uplink delay component is comprised of at least one of additional length of uplink communications medium and delay circuitry.

3. The distributed antenna system of claim 1, wherein the at least one additional uplink delay component is comprised of a plurality of the additional uplink delay components provided in each of the plurality of uplink communications paths.

4. The distributed antenna system of claim 1, further comprising at least one additional downlink delay component provided in at least one of the downlink communications paths to increase the signal propagation delay of the downlink RF communications signals to further increase the actual signal propagation delay of the plurality of downlink communications paths.

5. The distributed antenna system of claim 4, wherein the at least one additional downlink delay component is comprised of a plurality of the additional downlink delay components provided in a plurality of the downlink communications paths.

6. The distributed antenna system of claim 5, wherein the at least one additional uplink delay component and the at least one additional downlink delay component are balanced.

7. The distributed antenna system of claim 1, further comprising a look-up table in a database, the look-up table being configured to store assigned actual propagation delays for each of the plurality of RAUs and to store a location of each of the plurality of RAUs.

8. The distributed antenna system of claim 1, further comprising a processing device configured to:
determine the actual signal propagation delays for each of the plurality of RAUs; and
assign the actual signal propagation delays for each of the plurality of RAUs in a look-up table to uniquely identify each of the plurality of RAUs with the actual signal propagation delay determined for each of the plurality of RAUs.

9. The distributed antenna system of claim 1, further comprising a processing device configured to:
determine the actual signal propagation delay for an uplink RF communications signal;
correlate the actual signal propagation delay to the identity of a RAU among the plurality of RAUs to identify the RAU involved with the uplink RF communications signal; and
correlate the location of the client device communicating the uplink RF communications signal to the identified RAU with the location of the identified RAU.

10. The distributed antenna system of claim 1, wherein the processing device is configured to correlate the actual signal propagation delay to the identity of a RAU among the plurality of RAUs using a look-up table storing assigned actual propagation delays for each of the plurality of RAUs.

11. The distributed antenna system of claim 10, wherein the processing device is configured to correlate the location of the client device communicating the uplink RF communications signal to the identified RAU with the location of the identified RAU using a look-up table storing location of each of the plurality of RAUs.

12. The distributed antenna system of claim 1, wherein the HEE comprises:
a plurality of radio interfaces each configured to distribute the received downlink RF communications signals into first downlink electrical RF communications signals; and
a plurality of optical interfaces each configured to:
receive the first downlink electrical RF communications signals from the plurality of radio interfaces;
convert the received first downlink electrical RF communications signals from the plurality of radio interfaces into downlink optical RF communications signals; and
distribute the downlink optical RF communications signals over the downlink communications medium comprised of downlink optical fiber in the downlink communications paths to the plurality of RAUs.

13. The distributed antenna system of claim 1, wherein:
the plurality of optical interfaces are each further configured to:
receive uplink optical RF communications signals from the plurality of RAUs over the uplink communications paths;
convert the received uplink optical RF communications signals into received uplink electrical RF communications signals; and
distribute the uplink electrical RF communications signals to the plurality of radio interfaces.

14. A method of determining the location of a client device in a distributed antenna system, comprising:
determining the actual signal propagation delay for an uplink RF communications signal received from a remote antenna unit (RAU) among a plurality of RAUs each configured to communicate received downlink radio-frequency (RF) communications signals wirelessly to client devices and configured to receive uplink RF communications signals wirelessly from client devices
correlating the actual signal propagation delay to the identity of the RAU among the plurality of RAUs to identify the RAU involved with the uplink RF communications signal; and
correlating the location of the client device communicating the uplink RF communications signal to the identified RAU with a pre-configured location of the identified RAU.

15. The method of claim 14, further comprising head-end equipment (HEE)
receiving the downlink RF communications signals from a base station and distributing the received downlink communication RF signals over a plurality of downlink communications paths comprising a plurality of downlink communications medium each coupled to one of the plurality of remote antenna units (RAUs); and
receiving uplink RF communications signals over a plurality of uplink communications paths comprising a plurality of uplink communications medium each coupled to one of the plurality of RAUs.

16. The method of claim 15, further comprising increasing the actual signal propagation delay for the uplink RF communications signal using an additional uplink delay component provided in the uplink communications path of the uplink RF communications signal to increase a signal propagation delay of the uplink RF communications signals.

17. The method of claim 14, wherein the at least one additional uplink delay component is comprised of a plurality of the additional uplink delay components provided in a plurality of uplink communications paths.

18. The method of claim 14, further comprising increasing the signal propagation delay of the downlink RF communications signals to further increase the actual signal propagation delay of the plurality of downlink communications paths using at least one additional downlink delay component provided in at least one of the downlink communications paths.

19. The method of claim 18, wherein the at least one downlink delay component is comprised of at least one of additional length of downlink communications medium and delay circuitry.

20. The method of claim 18, wherein the at least one additional downlink delay component is comprised of a plurality of the additional downlink delay components provided in each of the plurality of downlink communications paths.
